(19) United States
(12) Patent Application Publication
(10) Pub. No.: US 2026/0086853 A1
(43) Pub. Date: Mar. 26, 2026

(54) AUTOMATIC SELECTION OF PRE-TRAINED LARGE LANGUAGE MODELS FOR FINE-TUNING USING TASK TRANSFERABILITY AND HISTORICAL USAGE INFORMATION

(71) Applicant: Dell Products L.P., Round Rock, TX (US)

(72) Inventors: Pablo Nascimento da Silva, Niterói (BR); Paulo Abelha Ferreira, Rio de Janeiro (BR); Vinicius Michel Gottin, Rio de Janeiro (BR)

(21) Appl. No.: 18/891,193

(22) Filed: Sep. 20, 2024

(51) Int. Cl. G06F 9/50

(52) U.S. Cl. CPC G06F 9/5027

(57) ABSTRACT

One example method includes receiving from a user, by a model selection (MS) module, a target dataset and a request for a model, transmitting, by the MS module, the target dataset to a pre-trained model management (PTMM) module, accessing, by the PTMM module, a priority list of pre-trained models, and selecting candidate pre-trained models for the given dataset, and transmitting the candidate pre-trained models to the MS module, training, by the MS module, each of the candidate pre-trained models to the target dataset, and sending metadata of the training to the PTMM module, using, by the PTMM module, the metadata to inform prioritization of the candidate pre-trained models, fine-tuning each of the candidate pre-trained models, and sending, by the MS module, an adapter, and a best model of the candidate pre-trained models, to an edge node for use in connection with the target dataset.

### TECHNOLOGICAL FIELD OF THE DISCLOSURE

Embodiments disclosed herein generally relate to identification and selection of a large language model (LLM) for a specific task. More particularly, at least some embodiments relate to systems, hardware, software, computer-readable media, and methods, for automatic selection of pre-trained large language models for fine-tuning using task transferability and historical usage information.

### BACKGROUND

Large Language Models (LLMs) have gained attention recently due to their ability to handle different natural language processing tasks. Training those models takes time and effort. To use these models in various tasks, the user usually performs a fine-tuning, or transfer learning, process which accelerates the development and training of these models for use on specific downstream tasks.

A problem in this scenario is deciding which pre-training model is most suitable for performing the new task. Training many different models to select the best one, even with fine-tuning, such as transfer learning, techniques, is computationally inefficient. Thus, there is a need for methods to automatically select the pre-trained model most suitable to transfer the learned features to the new task, while using minimal computational resources under a pre-defined budget.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a method according to one embodiment.

FIG. 2 discloses an overview of an example system structure and system initialization with new pre-trained models, according to one embodiment.

FIG. 3 discloses aspects of a method for selecting a collection of pre-trained model based on the target data and model priorities, according to one embodiment.

FIG. 4 discloses an overview of array information update and reprioritization of queues inside the system, according to one embodiment.

FIG. 5 discloses a computing entity configured and operable to perform any of the disclosed methods, processes, and operations.

### DETAILED DESCRIPTION OF SOME EXAMPLE EMBODIMENTS

Embodiments disclosed herein generally relate to identification and selection of a large language model (LLM) for a specific task. More particularly, at least some embodiments relate to systems, hardware, software, computer-readable media, and methods, for automatic selection of pre-trained large language models for fine-tuning using task transferability and historical usage information.

One or more example embodiments are concerned with methods and/or architectures that perform selection of pre-trained LLMs, or simply LMs, to be fine-tuned for one or more specific tasks. One or more of such embodiments may address circumstances such as, but not limited to, management of metadata and a large pool of pre-trained Large Language Models (LLMs) to identify the best model to apply fine-tuning on a new task, updated metadata of each model with historical information on the model usage, and performing such management and updating, while maintaining computational cost within a pre-defined budget. One such example method, performed in connection with a target dataset specified by a user, may comprise operations including: receiving, by a model selection module of a service from a user, the target dataset; passing the target dataset to a pre-trained model management module; accessing, by the model management module, a priority list of pre-trained models to select the best candidate models for the given dataset; sending, by the model management module, a collection of suitable pre-trained models to the model selection module; adapting, by the model selection module, each model to the given dataset Dₜ, and sending metadata of the training to the model management module; using, by the model management model, this metadata to help in the prioritization of pre-trained models; and, sending the best model to an edge node E₁ or other user or client for use with the target dataset.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that an embodiment may automatically select a pre-trained model best suited, as among a group of pre-trained models, for execution of a particular task. An embodiment may select a pre-trained model in a computationally efficient manner. An embodiment may employ task transferability to enable efficient and automatic selection of a pre-trained model. Various other advantages of one or Docket No: 16192.1087 more example embodiments will be apparent from this disclosure.

### A. Reference Materials

Reference may be made here to the following materials, all of which are incorporated herein by their respective entireties. If specifically referred to, the materials will be mentioned by their [X] numbers.

[1] Bao, Y., Li, Y., Shao-Lun, H., Zhang, L., Zamir, A. R., & Guibas, L. (2019). An Information-Theoretic Metric of Transferability for Task Transfer Learning. IEEE International Conference on Image Processing (ICIP).

[2] GoodFellow, 1., Bengio, Y., & Courville, A. (2016). Deep Learning (Vol. 1). MIT Press.

[3] Guo, Y., Honghui, S., Abshishek, K., Kristen, G., Tajana, R., & Rogerio, F. (2019). SpotTune: Transfer Learning through Adaptive Fine-tuning. IEEE Conference on Computer Vision and Pattern Recognition, (pp. 4805-4814).

[4] Nguyen, C. e. (2020). Leep: A new measure to evaluate transferability of learned representations. International Conference on Machine Learning. PMLR.

[5] Shaev-Shwartz, S., & Ben-David, S. (2014). Understanding machine learning: from theory to algorithms. Cambridge University Press.

### B. Aspects of an Example Context for One Embodiment

The following is a discussion of aspects of example context for an embodiment. This discussion is not intended to limit the scope of the claims or this disclosure, or the applicability of the embodiments, in any way.

One or more example embodiments are directed to solving the challenges posed by transfer learning in LLMs. To provide context for one embodiment, the following discussion will address deep neural network training, transfer learning and fine-tuning.

### B.1 Deep Neural Network (DNN) Training

Training of machine learning models relies on training algorithms, usually supported by optimization. This situation is the same for deep neural networks, which relies on the famous backpropagation algorithm and an optimization algorithm, Stochastic Gradient Descent (SGD) being the most prominent one, for a better explanation about this algorithm see [2].

Before initialization, one network topology of neurons and interconnecting weights must be chosen. This topology will determine how the calculations will flow through the neural network. After that, an initialization must be performed, which will set the weight values to some random or predefined values. Finally, the training algorithm will separate batches of data and flow them through the network. Afterward, one step of backpropagation occurs, which will set the direction of adjustment of each of the weights through the gradients. Finally, the weights will move by a small amount, ruled by the algorithm learning rate. This process will go on for as many batches as necessary until all training data is consumed. This greater iteration is called an epoch. The training will go on until a predefined number of epochs is reached, or any other criteria are met, for example, there is no significant improvement over the last p epochs.

### B.2 Transfer Learning

Transfer learning is the AI/ML (artificial intelligence/machine learning) field that studies the use of the knowledge gained while solving one problem and the application of this knowledge to a different but related domain. This field has gained some attention since one hope of AI is to have systems taking insights from one setting and applying them elsewhere. For example, if a user trained a classifier to predict whether an image contains a cat, the user could also use the knowledge that the model gained during its training to recognize other animals like dogs.

Presently, deep neural networks are applied to a broad set of domains, and transfer learning has emerged as a popular method in the development of deep learning models. Following is an example of two-stage training of deep neural network using transfer learning:
1. pretraining, where the network is trained on a large dataset representing a wide diversity of labels; and
2. fine-tuning, where the pretrained neural network is further trained on the specific target task of interest, which usually has fewer labeled examples than the original dataset.
   B.3 Fine-Tuning with LoRA and Adapters

One efficient technique for fine-tuning models is using Low-Rank Adaptation (LoRA) and related methods. These methods address the challenge of adapting large pre-trained models to specific tasks without using extensive computational resources or retraining the entire model. LoRA achieves this by introducing low-rank matrices into the model's weight space, effectively reducing the number of parameters that need to be updated during fine-tuning. This not only speeds up the training process but also minimizes the risk of overfitting and reduces memory consumption. On the other hand, ‘adapters’ are lightweight modules inserted into each layer of a pre-trained model. During fine-tuning, only the parameters of these adapters are updated, leaving the original model weights untouched. This modular approach allows for efficient multitask learning and transfer learning, as the same base model can be adapted to multiple tasks by swapping out the adapters. Both LoRA and adapters facilitate scalable and efficient model adaptation, making it feasible to leverage powerful pre-trained models in resource-constrained environments while maintaining high performance on specific tasks.

### B.4 Transferability Measures

Transferability estimation is the problem of quantitatively estimating how easy it is to transfer knowledge learned from one classification task to another. So, given a source task, represented by a labeled dataset or a pre-trained model, and a target task, represented by a labeled dataset, transferability estimation is defined as the score that inform us about how effectively transfer learning algorithms can transfer knowledge from the source task to the target task. This process should ideally be performed without any additional training. There are some examples of transferability measures in the literature, such as disclosed in [1] and [4]. Following is a description of LEEP as an example of possible methods to be used by this invention.

### B.4.1 Log Expected Empirical Prediction (LEEP)

LEEP ([4]) is a transferability measure developed to be simple and easy to compute. Assume source model θ and a target dataset D={(x₁, y₁), . . . , (xₙ, yₙ)}, LEEP computes the transferability score between θ and D in 3 steps as follows:
1. Apply θ to each input xᵢ to get a dummy label distribution θ(xᵢ)
   a. θ(xᵢ) is a distribution of the source label set Z
   b. Labels in Z may not semantically relate to true label yᵢ of xᵢ, e.g., Z is ImageNet labels and (x₁, y₁) is from the CIFAR dataset (see https://www.cs.toronto.edu/˜kriz/cifar.html)
2. Compute empirical conditional distribution of target label y given dummy source label z
a. Empirical joint distribution:

$$\hat{P} ( y , z ) = {\sum }_{i : {y}_{i} = y} \frac{{θ ( {x}_{i} )}_{z}}{n}$$

b. Empirical marginal distribution:

$$\hat{P} ( z ) = {\sum }_{y} \hat{P} ( y , z )$$

c. Empirical conditional distribution:

$$\hat{P} ( y \vert z ) = \frac{\hat{P} ( y , z )}{\hat{P} ( z )}$$

3. Expected Empirical Predictor (EEP)
   a. A classifier that predicts label y of an input x as follows:
      i. First, randomly drawing a dummy label z from θ(x)
      ii. Then, randomly drawing y from \hat{P}(y|z)
   b. In other words, y˜Σ_{z}\hat{P}(y|z) θ(xᵢ)_{z}
   c. LEEP is the average log-likelihood of EEP given data D

$$T ( θ , D ) = \frac{1}{n} {\sum }_{i} log ( {\sum }_{z} \hat{P} ( y \vert z ) θ {( {x}_{i} )}_{z} ) \qquad i .$$

### C. Overview of Some Aspects of One Embodiment

### C.1 Introduction

One example embodiment is configured, and operates, to automatically select a pre-trained model that is most useful to perform a fine-tuning procedure based on historical information collected by similar tasks, and in the capacity to transfer the features learned from one task to another. In one embodiment, all of this may be performed using minimal computational resources under a pre-defined budget. More specifically, an embodiment may comprise the following aspects:
Manage metadata and a large pool of pre-trained Large Language Models (LLMs) to identify the best model to apply fine-tuning on a new task.
Keep each model metadata updated with historical information on the model usage.
Perform the metadata management, and model metadata updates, while minimizing computational cost under a pre-defined budget.

One embodiment comprises a system configured and operable to identify the transferability of pre-trained models to a new task in an automated fashion. An embodiment may create a pool of models managed by the company. With that, an embodiment may build a repository of pre-trained models, in which it is possible to manage a list of the most suitable and valuable pre-trained models for each new task that the user, such as a customer for example, wants to train. Additionally, an embodiment may avoid costs with computational power to test many pre-trained models whenever a new training procedure is needed.

### C.2 Brief Discussion

One embodiment comprises a method and orchestration for the automatic selection of pre-trained large language models to be used in a fine-tuning procedure, that is, a procedure to adapt a pre-trained model to a new task. The method according to one embodiment may comprise building a pool of pre-trained models managed by a cloud services provider. So, when a client needs a pre-trained model for a new NLP (natural language processing) task, the client may query the cloud services provider to identify the best pre-trained model for its task and data. The cloud services provider may also provide, as a service (aaS), the fine-tuning procedure, returning a completely adapted model to the new task, but it will depend on the amount of data the client sends to the server.

In one embodiment, the best pre-trained model is identified using the following procedures. First, each model in the pre-trained model pool contains metadata with information about its training process and measures from previous utilization of the model. This metadata information is used to group models and pre-order them according to their predictive capacity. So, in the following step, an embodiment may select a subset of pre-trained models from the pool based on the input information and the pre-ordered models. The final identification of the best pre-trained model is made by employing a transferability metric, as disclosed in [1] and [4] for example, that comprises a function that evaluates the capacity of a machine learning model to perform well given a model and the target data. This can be performed without training the model, saving computational resources.

Additionally, in one embodiment, the model pool service provides mechanisms to rank the pre-trained models by task, domain, and related data so that the embodiment can prioritize the evaluation of the most suitable pre-trained models. In one embodiment, this prioritization may be calculated using two metrics, namely, (1) the number of times a given model is selected and (2) the quality of the resulting model, that is, the model obtained after the fine-tuning procedure has been performed. In an embodiment, this step may be necessary when the number of pre-trained models is large for that specific domain.

### C.3 Conclusion

As outlined above, and disclosed elsewhere herein, an embodiment may possess various useful features and aspects, although no embodiment is required to possess any of such features or aspects. The following examples are illustrative, but not exhaustive. An embodiment may comprise a system configured and operable to manage a pool of pre-trained models organized by model characteristics and ordered by metadata with historical information. An embodiment may comprise a method for prioritizing pre-trained models in the pool to reduce the computational resources needed in selecting the best pre-trained model for fine-tuning a new task. Finally, an embodiment may comprise a method that employs an adapted transferability measure to select the best model from the pool of pre-trained models to be used to fine-tune a new task.

### D. Detailed Discussion of Aspects of One Embodiment

One embodiment comprises a mechanism for automatically selecting the most suitable pre-trained model to be used in along with a fine-tuning strategy to adapt the model to the user data and task. One of the goals of this mechanism is to provide management and tools for handling large scale models in a service provided by a cloud services, or other, provider. This facilitates the deployment of LLMs for new tasks since the correct selection of the pre-trained model can reduce the time used for training a new model by a large amount. More than that, the correct selection of the pre-trained model allows for training models using a limited amount of data from the target task.

### D.1 Overview

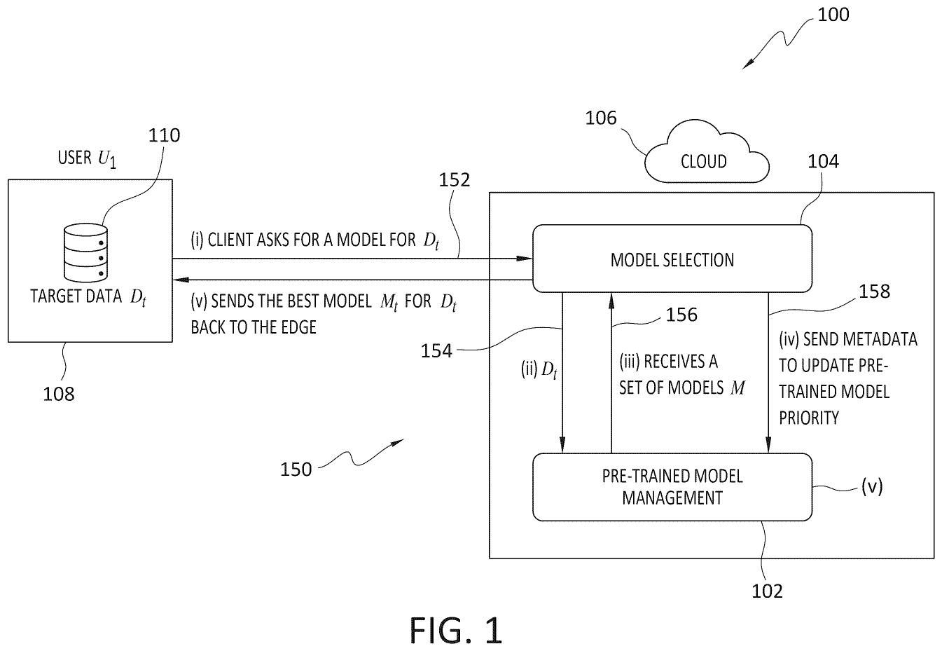

With attention now to the example architecture 100 disclosed in FIG. 1, an embodiment may comprise two modules. The first module is a pre-trained model management (PTMM) module 102 that operates to manage the pre-trained models and their metadata in the cloud and is responsible for prioritizing the models that will be selected to adapt the model to the new task. The second module is a model selection (MS) module 104 that may be used by an end-user. In one embodiment, the MS module 104 receives a limited set of pre-trained models, selected by the PTMM module 102, applies the fine-tuning procedure which produces an adapter to be sent to the user, and selects the best final model. The metadata generated in the MS module 104 may also be used to update the prioritization procedure of the PTMM module 102. As shown in FIG. 1, the PTMM module 102 and the MS module 104 may be hosted at a cloud site 106, although that is not required. In another embodiment, one or both of the PTMM module 102 and the MS module 104 may be hosted at a user premises, or other site(s).

In more detail, and with continued reference to the example of FIG. 1, a method 150 according to one embodiment may proceed as follows:
(i) a user client U₁ 108 requests 152 a model to its target dataset Dₜ 110, so it asks a cloud service for a model;
(ii) the MS module 104 receives the request 152 and passes 154 the data of the target dataset Dₜ 110 to the PTMM module 102, which then accesses a priority list of pre-trained models to select the best candidate models for the given target dataset Dₜ 110;
(iii) the MS module 104 then receives 156, from the PTMM module 102, a collection of suitable pre-trained models;
(iv) the MS module 104 adapts each of the pre-trained models received 156 from the PTMM module 102 to the given dataset Dₜ, and sends 158 metadata of the training to the PTMM module 102;
(v) the PTMM module 102 uses the metadata received from the MS module 104 to help in the prioritization of pre-trained models, and then sends the best model to the edge node E₁ and/or other destination.

### D.2 Example Pre-Trained Model Management (PTMM) Module

In one embodiment, the PTMM module 102 handles the pre-trained models and inserts the pre-trained models into a priority order to be selected easily whenever a new query is received by the system from a user, or other requestor(s). In one embodiment, this selection may be governed by the notion that if a model is more suitable for a large variety of tasks, rather than a relatively smaller variety of tasks, then it should be selected and tested first.

In an embodiment, the PTMM module 102 manages a large pool of pre-trained models P, their associated priority queues Q, and two statistics arrays S and T calculated and managed by an embodiment of the method. The S array represents the potential transferability score, while the array T accumulates the training statistics of each pre-trained model m∈Q. The pre-trained models are organized by input type, examples of which include, but are not limited to, vocabulary size, trained language, and original task, so that each different type of input is associated with its own respective priority queue q_{c} of pre-trained models, where 1≤c≤|Q|. Initially, the priority of each pre-trained model can be determined by the accuracy of the model when performing its source, or native, tasks.

### D.2.1 Initializing the System

Before enabling queries by a user, an embodiment may populate a pool of pre-trained models P and their associated priority queues Q, the priority queues are selected according to the interest of a service provider in keeping different types of models. So, in this step, the owner of the system may include pre-trained models in the pool. These models may come from a large variety of domains, architectures and tasks that could be either previously trained internally or open-source models.

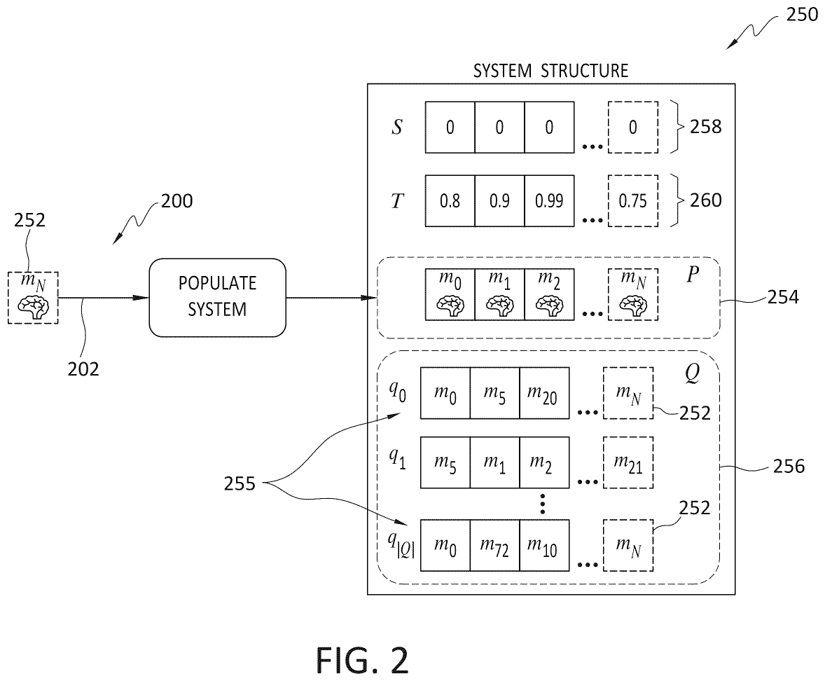

With reference now to the example of FIG. 2, there is disclosed an overview of a system structure, and initialization, of a system with new pre-trained models, according to one embodiment. More specifically, FIG. 2 discloses a method 200 for populating a system 250.

In one embodiment, the example method 200 may proceed as follows. First, a pre-trained model m 252 may be selected 202 to be included in the system 250. The input data used to train model m 252 may be used as proxy to its priority queue, for example, all pre-trained models 254 with the same vocabulary size are put in the same priority queue(s) 255, which may be one member of a pool 256 of priority queues, since those models tend to use the same tokenizer. In one embodiment, each pre-trained model, such as the pre-trained model m 252, may belong to one or more priority queues 255, depending on their input conditions. For example, all models trained with the same language may be placed in the same priority queue.

Second, after adding the pre-trained model m 252 to one or more priority queues 255, an embodiment may initialize the statistics S 258 and T 260. In one embodiment, the statistic S 258 may be initialized with a value of 0, and the statistic T 260 with the accuracy on the training source task. So initially, every pre-trained model m 252 in a priority queue 255 may be given the priority related with their initial accuracy in performing a particular task, which may be native to the pre-trained model m 252, that is, the particular task for which the pre-trained model m 252 was initially trained.

### D.2.2 Selecting a Collection of Pre-Trained Models

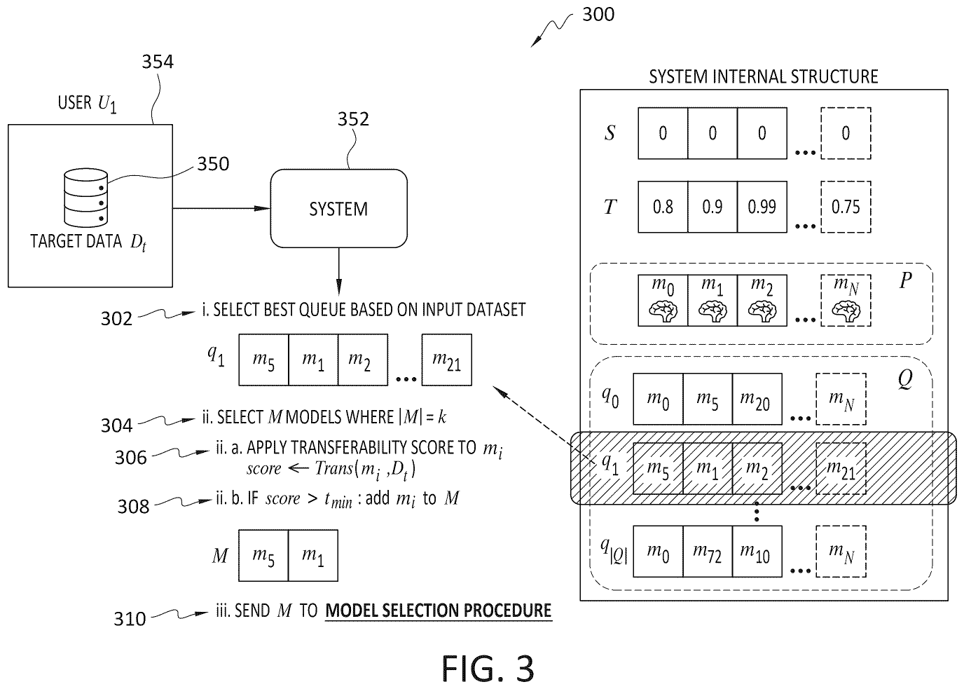

With reference now to the example of FIG. 3, details are provide concerning an example method 300 for selecting a collection of pre-trained model based on the target data and model priorities. In particular, when a new target dataset 350 arrives, such as at a service/system 352, from a user 354 or other source, an embodiment may select the best collection of models to send back to the MS module 104. Thus, in one embodiment, a service receives a target dataset Dₜ, the input of the model, the size of the model collection k, a transferability measure Trans and a threshold of minimum transferability tₘᵢₙ.

In one example embodiment, the method 300 may proceed as follows:
(i) use the input type of the model to select 302 the correct priority queue q_{c}∈Q, and initialize M←{ }, the collection of selected pre-trained models;
(ii) while |M|<k, and priority queue has unseen elements, select 304 M models where |M|=k:
   ii.a. apply 306 transferability measure to mᵢ: get the score score←Trans(mᵢ, Dₜ), where Trans is the transferability measure and mᵢ is the iₜₕ element of the priority queue q_{c}; and
   ii.b. if score>tₘᵢₙ: add 308 mᵢ to M and add score to the array of scores S else: go evaluate mᵢ₊₁; and
(iii) return 310 M to the model selection procedure.

### D.3 Model Selection

The MS module 104 applies the fine-tuning method using the provided target dataset and the collection of most suitable pre-trained models. The pre-trained models come from the PTMM module 102 after application of the transferability measure and other prioritization strategies.

In one embodiment, the MS module 104 may operate as follows (see also, FIG. 1):
(1) divide the target dataset Dₜ into two parts, a training dataset D_{t_train} and a validation dataset D_{t_val}—these datasets are used to select the best final model and avoid overfitting;
(2) after receiving the collection M of pre-trained models from the model management, evaluate each one of the models on the validation dataset—for doing that, one embodiment may initially define the type of evaluation to be performed, the user can send some options in a configuration file, where such options may include, for example, the type of validation (k-fold, or hold-out, for example), evaluation measure (accuracy, f-measure, and perplexity, for example), fine-tuning method and its parameters (LoRA, QLoRA), number of training epochs, among others;
(3) apply a fine-tuning procedure, which may be defined in the configuration file, to each one of the pre-trained models in M—for each model training, an embodiment may save the metadata containing the accuracy, or any defined evaluation measure, for each epoch, and the final evaluation in the validation dataset and the test dataset, and an embodiment may also save the adapter produced by the fine-tuning process.
(4) in an embodiment, the training procedure uses only the training dataset D_{t_train} for adapting the model to the target task, the validation dataset D_{t_val} is used to get the final measure—so that, in the end, for each model m in M, an embodiment stores a vector T with the validation accuracy for that model m; and
(5) the best model is the one with the highest, or best, value, depending on the evaluation measure being used, value in the vector T—this model, together with the adapter matrix, is then returned to an edge client E₁ or other entity, and the collected metadata is sent to the PTMM module 102 in order to update the priority of the pre-trained models.
   D.3.1 Keeping Computational Costs within a Specified Budget

In an embodiment, each model mᵢ can accumulate in its associated vector T the information about its training statistics using LoRA configurations. The information in a vector T may include, for example, the number of layers being fine-tuned, the updated parameters, the LoRA parameters that build the adapter matrix, and the training time on a given GPU, among others. With all this information available, an embodiment may select, and limit, the fine-tuning time based on previous iterations with the system. A budget may be defined, so an embodiment may prioritize the models that will efficiently run under the given configuration. The budget may be defined in any suitable terms including, but not limited to, time, cost in financial terms, and cost in terms of computing resources required, such as the number of GPU operations.

### D.4 Updating the Priority of Pre-Trained Models

In one embodiment, after the model selection procedure, the PTMM module 102 receives the array T containing the respective training statistics of each model in the collection M when adapted using fine-tuning in the target dataset Dₜ. Additionally, the array of transferability scores S is also used to update the priority of the models in the selected queue. In one embodiment, this updating may comprise the following operations, all of which may be performed by the PTMM module 102:
1. for the process of user U₁, receiving the statistics array T;
2. obtaining the correct priority queue—the PTMM module 102 stores this information at the time it processes the selection of pre-trained models, as discussed elsewhere herein;
3. for each m∈M, the collection of selected pre-trained models, updating the priority value of each model m:
   a. this update may be based on two values, namely, the statistics vector T, and the vector of transferability scores S;
   b. thus,

$${q}_{c}^{m} [ {}^{‵} {priority}^{′} ] ← F ( {S}_{m} , {T}_{m} ) ,$$

where F is any aggregation function considering the statistics of the fine-tuning, the transferability measure, and the number of times a given model is selected; and
c. one example of such a function F is an average function

$$F ( {S}_{m} , {T}_{m} ) = \frac{( {S}_{m} , {T}_{m} )}{2} -$$

in this approach, priority scores are higher for models that are more selected and with higher statistics and transferability; and
4. End Update

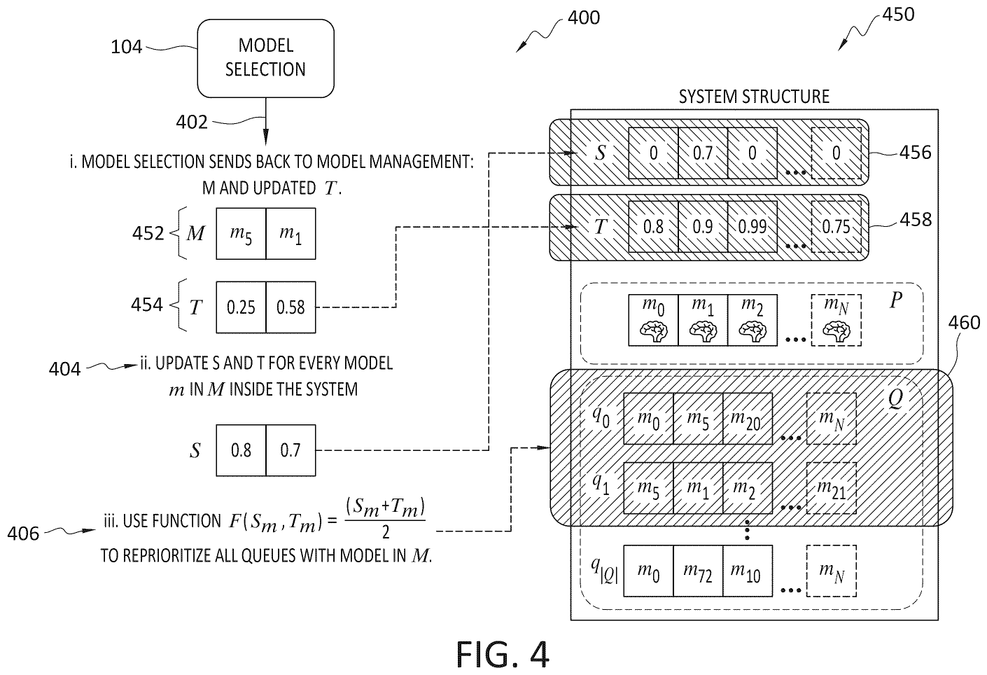

With attention now to FIG. 4, an example method 400 comprising a process for updating the arrays with information about the model execution, and reprioritizing of the queues inside the system, is disclosed. In general, a priority update may make the selection of a specific set of models much more frequent so that, consequently, some models may never be used. To avoid this, an embodiment may implement a priority score decay. So, after a considerable number of system usage, an embodiment may decrease the priority score of the head elements of the queue by a given value v, defined by the system owner.

With particular reference now to the method 400, and an example system 450, one embodiment may comprise the following operations:
(i) MS module 104 sends 402 a collection M 452 of pre-trained models, and a respective updated statistics vector T 454 for each of the pre-trained models;
(ii) updating 404, in the system 450, the statistics arrays S 456 and T 458 for every pre-trained model m in M 452; and
(iii) using 406 function

$$F ( {S}_{m} , {T}_{m} ) = \frac{( {S}_{m} , {T}_{m} )}{2}$$

to reprioritize all queues 460 with models in M 452.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other byway of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method, comprising: receiving from a user, by a model selection (MS) module, a target dataset and a request for a model; transmitting, by the MS module, the target dataset to a pre-trained model management (PTMM) module; accessing, by the PTMM module, a priority list of pre-trained models, and selecting candidate pre-trained models for the target dataset, and transmitting the candidate pre-trained models to the MS module; training, by the MS module, each of the candidate pre-trained models to the target dataset, and sending metadata of the training to the PTMM module; using, by the PTMM module, the metadata to inform prioritization of the candidate pre-trained models; fine-tuning each of the candidate pre-trained models; and sending, by the MS module, an adapter, and a best model of the candidate pre-trained models, to an edge node for use in connection with the target dataset.

Embodiment 2. The method as recited in claim 1, wherein the MS module and the PTMM module are elements of a cloud service provider that communicates with the user.

Embodiment 3. The method as recited in claim 1, wherein each of the pre-trained models is included in one or more priority queues, based on respective input characteristics of each of the pre-trained models.

Embodiment 4. The method as recited in claim 3, wherein an initial position of each of the pre-trained models within a queue is based on an accuracy of the pre-trained model in solving a problem native to that pre-trained model.

Embodiment 5. The method as recited in claim 3, wherein after the best model has been selected, an array of transferability scores, comprising a respective transferability score for each of the pre-trained models, is used to update a priority of the pre-trained models in the queues.

Embodiment 6. The method as recited in claim 1, wherein each of the candidate pre-trained models is selected based, at least in part, on: the target dataset; a respective input type of the candidate pre-trained model; a transferability measure of the pre-trained model; and, a minimum transferability threshold for the pre-trained model.

Embodiment 7. The method as recited in claim 1, wherein each of the candidate pre-trained models is associated with a respective statistics vector, and a vector of transferability scores.

Embodiment 8. The method as recited in claim 1, wherein the best model is selected by: dividing the target dataset into a training dataset and a validation set; evaluating each of the candidate pre-trained models using the validation set; training each of the candidate pre-trained models using the training dataset to adapt the candidate pre-trained models to perform a task implied by the target dataset; and deeming the pre-trained model with a highest validation accuracy as the best model.

Embodiment 9. The method as recited in claim 1, wherein information included in a respective vector of transferability scores for each of the pre-trained models is used to limit, within a specified budget, a computational cost of performing the fine tuning on each of the candidate pre-trained models to suit the candidate pre-trained models to perform a task associated with the target dataset.

Embodiment 10. The method as recited in claim 1, wherein metadata generated during the fine-tuning is used by the PTMM module to prioritize the candidate pre-trained models, and identify the best model of the candidate pre-trained models.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

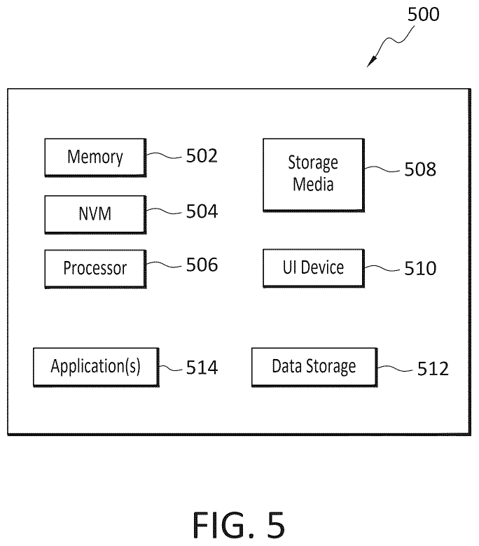

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving from a user, by a model selection (MS) module, a target dataset and a request for a model;
transmitting, by the MS module, the target dataset to a pre-trained model management (PTMM) module;
accessing, by the PTMM module, a priority list of pre-trained models, and selecting candidate pre-trained models for the target dataset, and transmitting the candidate pre-trained models to the MS module;
training, by the MS module, each of the candidate pre-trained models to the target dataset, and sending metadata of the training to the PTMM module;
using, by the PTMM module, the metadata to inform prioritization of the candidate pre-trained models;
fine-tuning each of the candidate pre-trained models; and
sending, by the MS module, an adapter, and a best model of the candidate pre-trained models, to an edge node for use in connection with the target dataset.

2. The method as recited in claim 1, wherein the MS module and the PTMM module are elements of a cloud service provider that communicates with the user.

3. The method as recited in claim 1, wherein each of the pre-trained models is included in one or more priority queues, based on respective input characteristics of each of the pre-trained models.

4. The method as recited in claim 3, wherein an initial position of each of the pre-trained models within a queue is based on an accuracy of the pre-trained model in solving a problem native to that pre-trained model.

5. The method as recited in claim 3, wherein after the best model has been selected, an array of transferability scores, comprising a respective transferability score for each of the pre-trained models, is used to update a priority of the pre-trained models in the queues.

6. The method as recited in claim 1, wherein each of the candidate pre-trained models is selected based, at least in part, on: the target dataset; a respective input type of the candidate pre-trained model; a transferability measure of the pre-trained model; and, a minimum transferability threshold for the pre-trained model.

7. The method as recited in claim 1, wherein each of the candidate pre-trained models is associated with a respective statistics vector, and a vector of transferability scores.

8. The method as recited in claim 1, wherein the best model is selected by:
dividing the target dataset into a training dataset and a validation set;
evaluating each of the candidate pre-trained models using the validation set;
training each of the candidate pre-trained models using the training dataset to adapt the candidate pre-trained models to perform a task implied by the target dataset; and
deeming the pre-trained model with a highest validation accuracy as the best model.

9. The method as recited in claim 1, wherein information included in a respective vector of transferability scores for each of the pre-trained models is used to limit, within a specified budget, a computational cost of performing the fine tuning on each of the candidate pre-trained models to suit the candidate pre-trained models to perform a task associated with the target dataset.

10. The method as recited in claim 1, wherein metadata generated during the fine-tuning is used by the PTMM module to prioritize the candidate pre-trained models, and identify the best model of the candidate pre-trained models.

11. A non-transitory storage medium having stored therein instructions that are executable by one or more hardware processors to perform operations comprising:
receiving from a user, by a model selection (MS) module, a target dataset and a request for a model;
transmitting, by the MS module, the target dataset to a pre-trained model management (PTMM) module;
accessing, by the PTMM module, a priority list of pre-trained models, and selecting candidate pre-trained models for the target dataset, and transmitting the candidate pre-trained models to the MS module;
training, by the MS module, each of the candidate pre-trained models to the target dataset, and sending metadata of the training to the PTMM module;
using, by the PTMM module, the metadata to inform prioritization of the candidate pre-trained models;
fine-tuning each of the candidate pre-trained models; and
sending, by the MS module, an adapter, and a best model of the candidate pre-trained models, to an edge node for use in connection with the target dataset.

12. The non-transitory storage medium as recited in claim 11, wherein the MS module and the PTMM module are elements of a cloud service provider that communicates with the user.

13. The non-transitory storage medium as recited in claim 11, wherein each of the pre-trained models is included in one or more priority queues, based on respective input characteristics of each of the pre-trained models.

14. The non-transitory storage medium as recited in claim 13, wherein an initial position of each of the pre-trained models within a queue is based on an accuracy of the pre-trained model in solving a problem native to that pre-trained model.

15. The non-transitory storage medium as recited in claim 13, wherein after the best model has been selected, an array of transferability scores, comprising a respective transferability score for each of the pre-trained models, is used to update a priority of the pre-trained models in the queues.

16. The non-transitory storage medium as recited in claim 11, wherein each of the candidate pre-trained models is selected based, at least in part, on: the target dataset; a respective input type of the candidate pre-trained model; a transferability measure of the pre-trained model; and, a minimum transferability threshold for the pre-trained model.

17. The non-transitory storage medium as recited in claim 11, wherein each of the candidate pre-trained models is associated with a respective statistics vector, and a vector of transferability scores.

18. The non-transitory storage medium as recited in claim 11, wherein the best model is selected by:
dividing the target dataset into a training dataset and a validation set;
evaluating each of the candidate pre-trained models using the validation set;
training each of the candidate pre-trained models using the training dataset to adapt the candidate pre-trained models to perform a task implied by the target dataset; and
deeming the pre-trained model with a highest validation accuracy as the best model.

19. The non-transitory storage medium as recited in claim 11, wherein information included in a respective vector of transferability scores for each of the pre-trained models is used to limit, within a specified budget, a computational cost of performing the fine tuning on each of the candidate pre-trained models to suit the candidate pre-trained models to perform a task associated with the target dataset.

20. The non-transitory storage medium as recited in claim 11, wherein metadata generated during the fine-tuning is used by the PTMM module to prioritize the candidate pre-trained models, and identify the best model of the candidate pre-trained models.
